(19) United States
(12) Patent Application Publication
(10) Pub. No.: US 2007/0039496 A1
(43) Pub. Date: Feb. 22, 2007

(54) Cylinder of an inking or dampening system

(76) Inventors: Jochen Sieber, Eichelsee (DE); Andreas Ewald Heinrich Bernard, Sulzfeld (DE); Manfred Herrmann Liebler, Erlenbach (DE)

Correspondence Address: Douglas R. Hanscom;Jones Tullar Cooper, P O Box 2266 Eads Station, Arlington, VA, 22202, US

(21) Appl. No.: 10/564,011

(22) PCT Filed: Jul. 7, 2004
(86) PCT No.: PCT/EP04/51378

§ 371 Date: Aug. 21, 2006

(30) Foreign Application Priority Data
Jul. 11, 2003 (DE) 103 31 595.0
Nov. 11, 2003 (DE) 103 52 614.5

(51) Int. Cl. B41F 31/00

(52) U.S. Cl. 101/352.06

(57) ABSTRACT

A cylinder, which is part of an inking system or of a dampening system, has a rotary individual drive which is embodied as a drive motor. A changeable drive is also provided. The rotary drive is driven by the drive motors by a bevel or angular gear.

The invention relates to a roller of an inking or dampening system in accordance with the preamble of claim 1, 6 or 15.

DE 197 20 954 A1 discloses a printing group with a vibrator inking system having three distribution cylinders and a dampening system having one distribution cylinder. The ink flow takes place starting at a distribution cylinder of the inking system remote from the cylinder, respectively via an inking roller parallel to two distribution cylinders closer to the transfer cylinder, and from there via respectively assigned application rollers to the transfer cylinder. The three-roller dampening system is always in active contact with one of the inking system distributors, so that a dampening agent/ink emulsion is applied.

A film inking system having three distribution cylinders is known from DE 197 50 960 A1, wherein the ink flow takes place from a distribution cylinder remote from the cylinder to a second distribution cylinder, and from there parallel via application rollers to the forme cylinder and the third distribution cylinder, from which smoothing of the ink application takes place via further application rollers.

A film inking system is represented in DE 101 03 842 A1, wherein an angle between a metering gap and a film gap, as well as an angle between the film gap and a press gap lies between 70° and 110°, in particular at approximately 90°.

DE 29 32 105 A1 shows a printing group with a vibrator inking system and a dampening system, wherein the dampening system is movably arranged in such a way that in one operating mode it acts as a three-roller dampening system, wherein no connection with the inking system exists, and in the other operating mode the dampening distribution cylinder has contact with an application roller of the inking system.

A film inking system is known from DE 38 04 204 A1 wherein, in addition to a zoned metering of the ink flow arranged in one area of the ink fountain, it is possible to take ink from the inking system via an intermediate roller and a doctor blade arrangement for variable regulation or for cleaning purposes.

A distribution cylinder of a printing press is disclosed in DE 101 57 243 A1, whose rotatory drive mechanism is arranged on its one end, and a traversing drive mechanism on the other, for example the driven side. Rotatory driving is provided by the motor either axially directly, or via a pinion gear to a spur wheel of the cylinder.

Transfer rollers of an inking system are seated on spring-loaded support levers in DE 38 04 204 A1.

The object of the invention is based on producing a roller of an inking or dampening system.

In accordance with the invention, this object is attained by means of the characteristics of claims 1, 6 or 15.

In an advantageous embodiment, the ink from the first distribution cylinder reaches the forme cylinder selectively or simultaneously over different possible paths (in series or parallel) via two further distribution cylinders. By means of this the inking system can be very flexibly changed to printing conditions with different requirements. The same applies to the printing group in view of the selective assignment of a distribution cylinder to the dampening or the inking system, as well as a possibility of a selection between “purely” dampening (direct) and indirect dampening, wherein ink and dampening agent are already mixed on a distribution cylinder.

An embodiment is also advantageous wherein rotatory driving of the dampening distributor by its own motor, in particular by means of a (corner) gear, takes place. For simplifying the drive train in regard to bringing it in and out of contact, the motor is advantageously also co-located on a lever.

By means of an advantageous arrangement of levers of two cooperating rollers, an embodiment is created which is simple to adjust, but nevertheless maintains their relative position to each other when being displaced.

In an advantageous embodiment, for an ideal ink flow through the printing group, ink is taken from the inking system in a specific way - and for example as a function of a printing image and/or a web width -. In this way no oversaturation of non-removed ink occurs, in particular in the edge areas.

Exemplary embodiments of the invention are represented in the drawings and will be described in greater detail in what follows.

Shown are in:

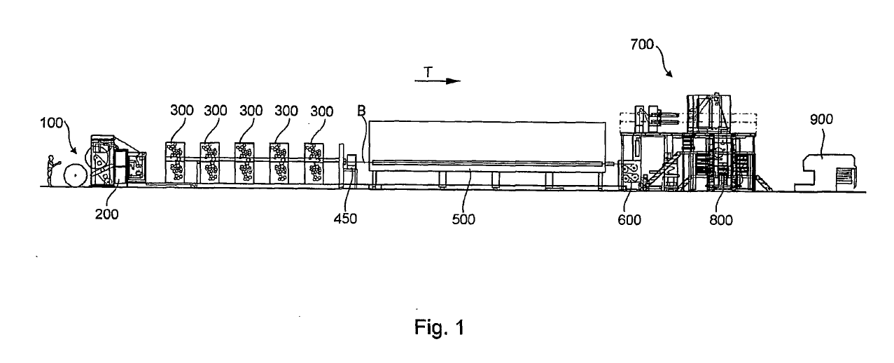

FIG. 1, an overview of a printing press,

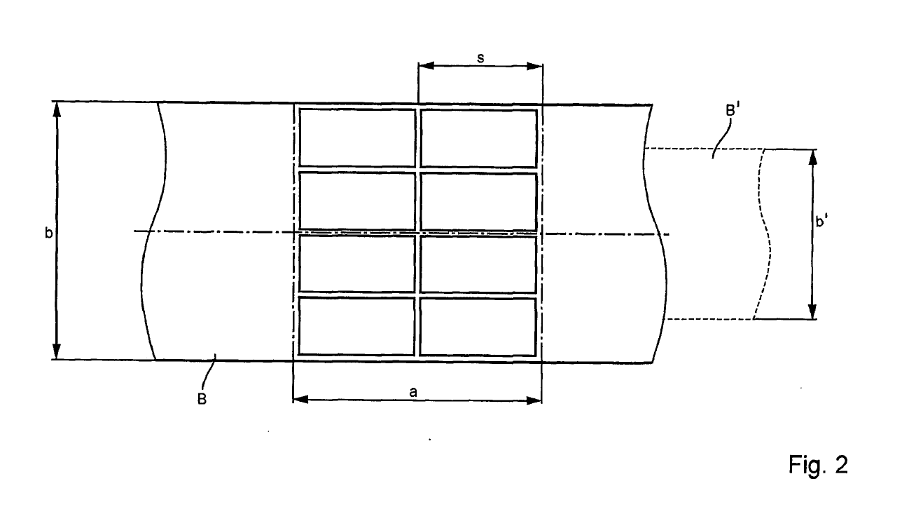

FIG. 2, a schematic representation of webs of different width,

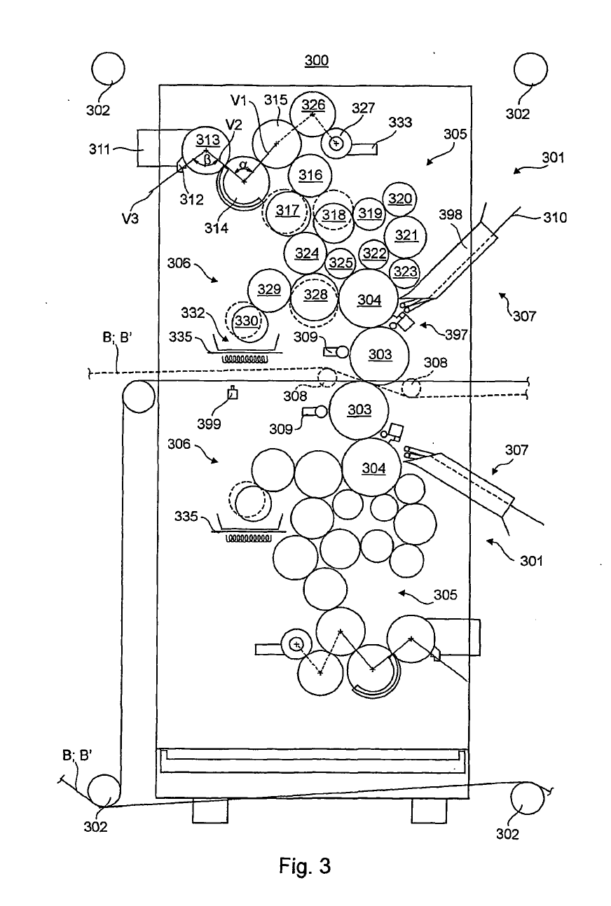

FIG. 3, a printing unit,

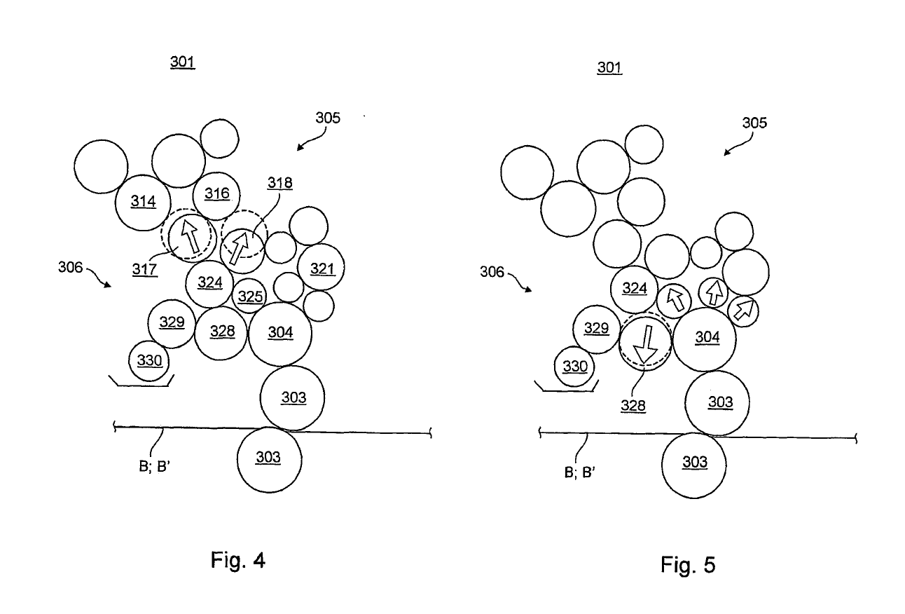

FIG. 4, a mode of operation of an inking system,

FIG. 5, a mode of operation of a dampening system,

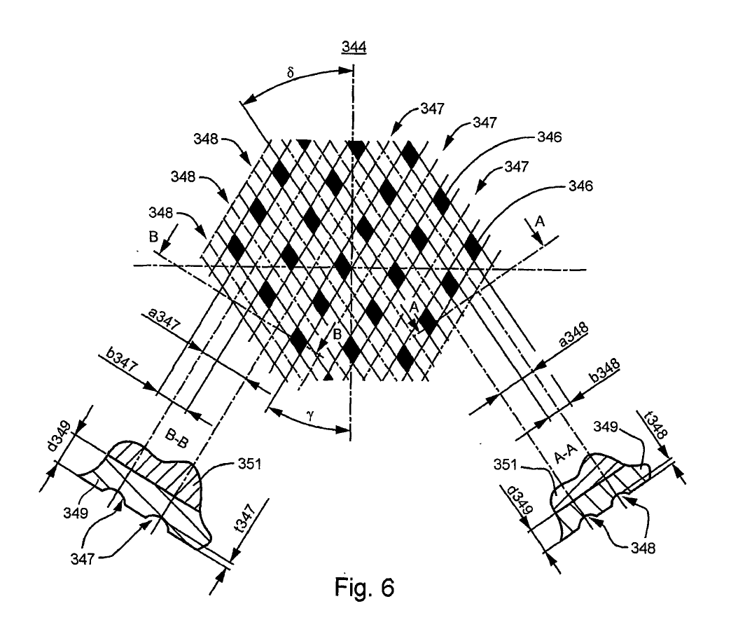

FIG. 6, a surface structure of a film roller,

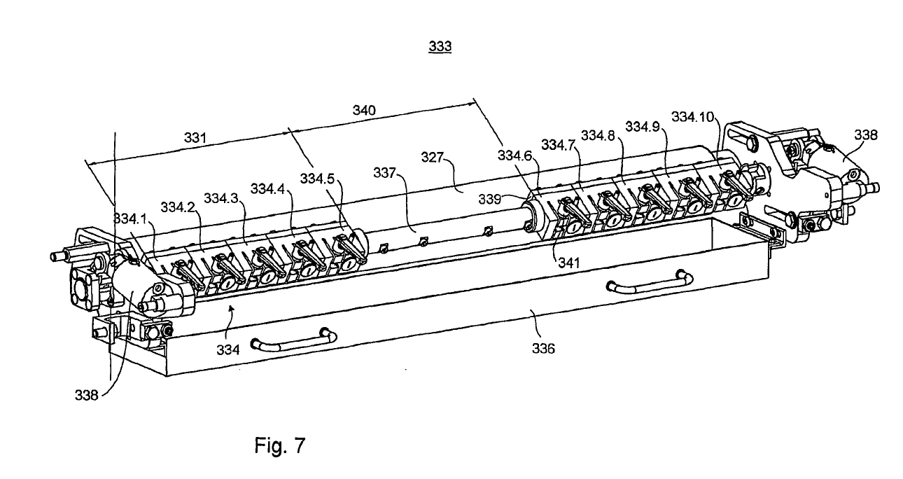

FIG. 7, a take-off device,

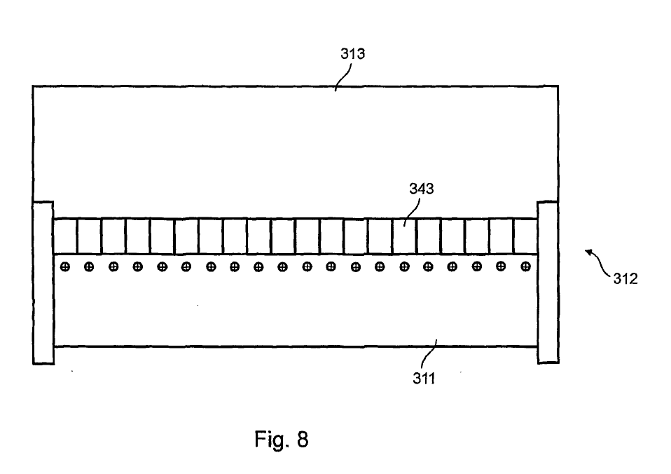

FIG. 8, ink feeding device into the inking system,

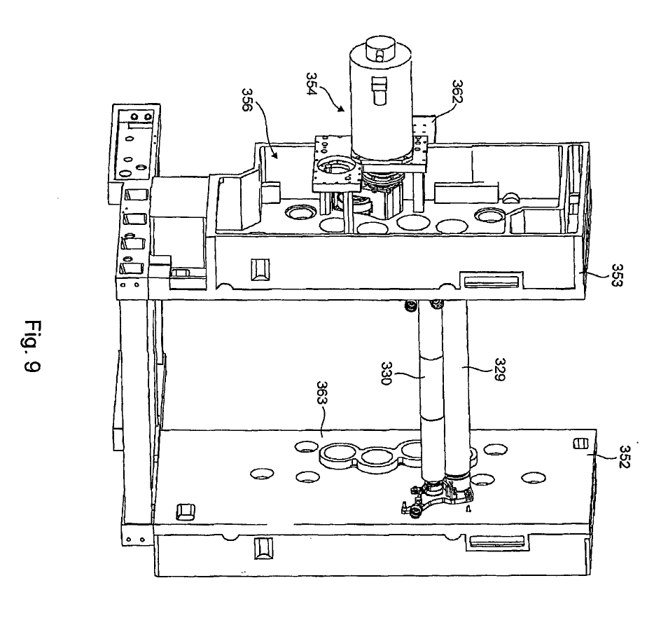

FIG. 9, a frame of the printing unit with a main drive mechanism and dampening system rollers,

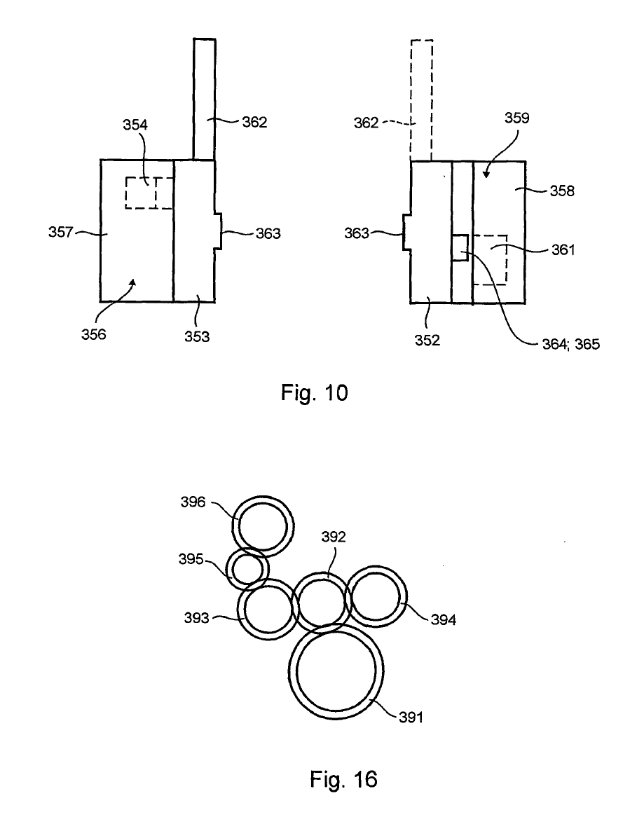

FIG. 10, a view from above on the frame with covers and a lug,

FIG. 11, a suspension and drive mechanism of dampening system rollers,

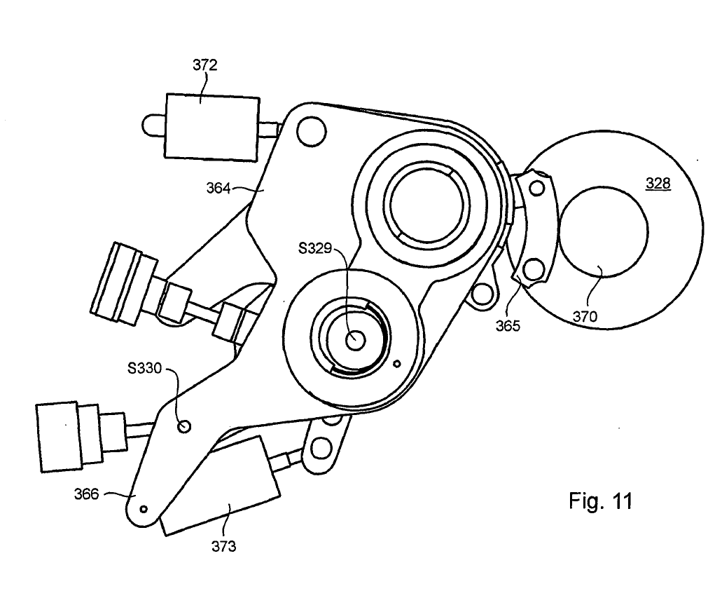

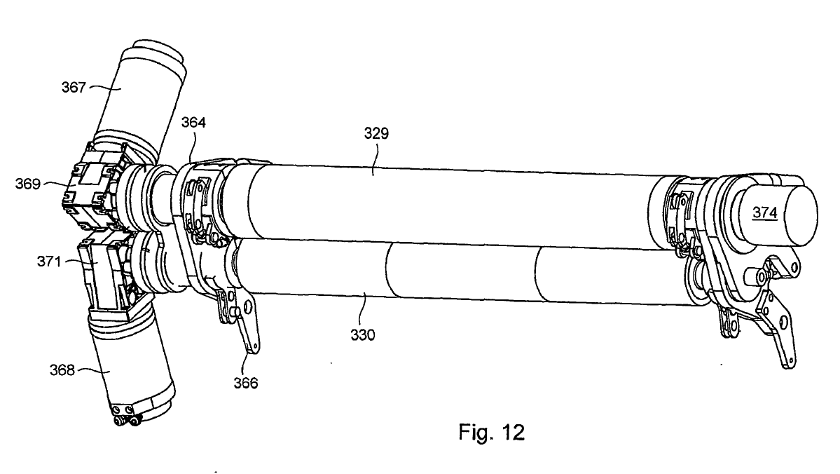

FIG. 12, an oblique view of dampening system rollers,

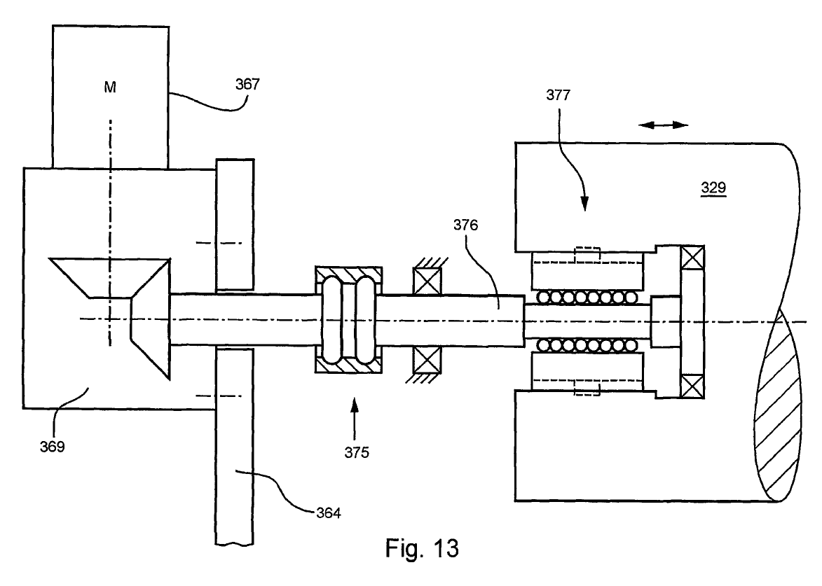

FIG. 13, a rotatory drive mechanism of an axially movable roller,

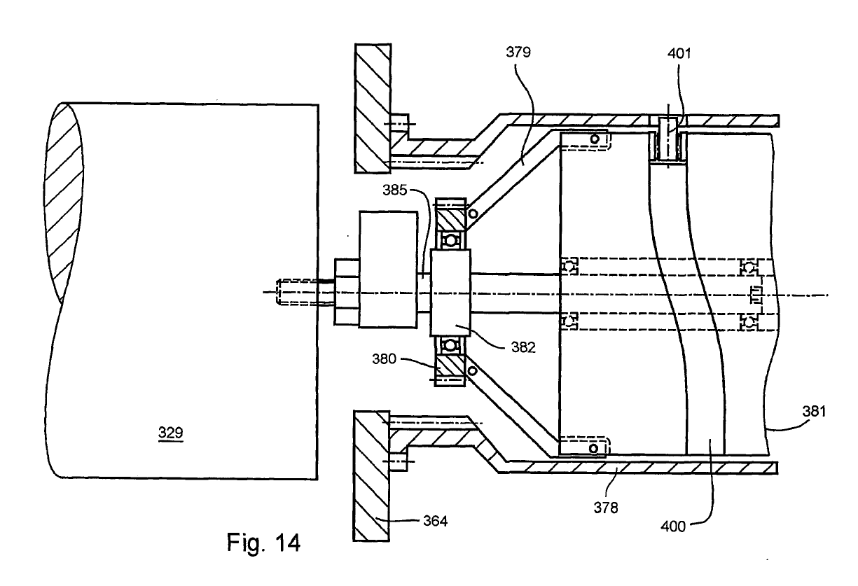

FIG. 14, an axial drive mechanism of a rotatable roller,

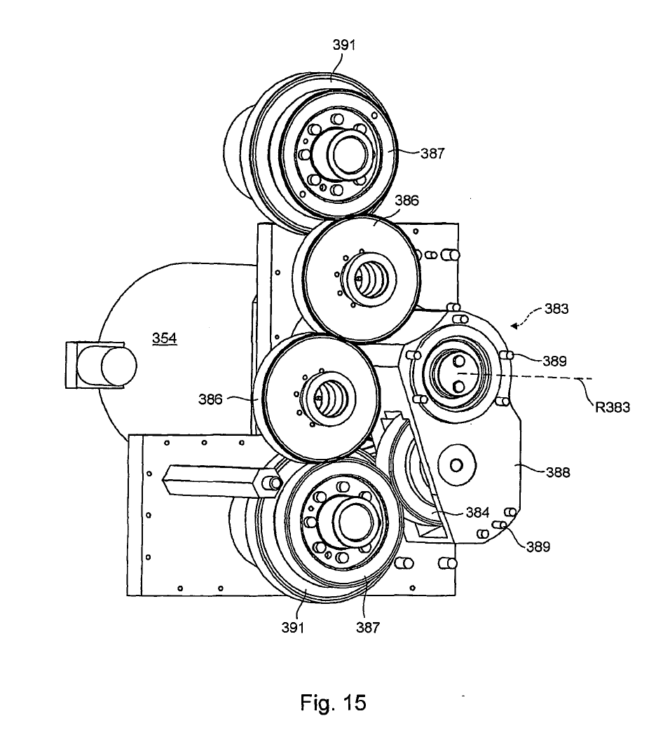

FIG. 15, a drive mechanism of the printing group cylinders,

FIG. 16, a drive mechanism of the inking system rollers.

A printing press, in particular a web-fed rotary printing press for imprinting one or several webs B, has several units 100, 200, 300, 400, 500, 600, 700, 800, 900 for provisioning, imprinting and further processing. For example, the web B to be imprinted, in particular a paper web B, is wound off a roll unwinding device 100 before it is supplied via a draw-in unit 200 to one or several printing units 300. In addition to the printing units 300, which are standardized for multi-color printing (for example four of them for four-color printing), it is possible to provide further printing units 300, which in this case can be utilized in alternation with one or several of the remaining printing units for flying printing forme changes.

In an advantageous embodiment a varnishing unit 450 can be provided in the web path.

Following imprinting and, if required, varnishing, the web B passes through a dryer 500 and is possibly cooled again in a cooling unit 600 if drying is performed thermally. A further conditioning unit such as, for example, a coating device and/or re-moistening device, not represented in FIG. 1, can be provided downstream of the dryer 500 in or downstream of the cooling unit 600. Following cooling and/or conditioning, the web B can be supplied via a superstructure 700 to a folding apparatus 800. The superstructure 700 has at least one silicon unit, longitudinal cutter and turning device, as well as a hopper unit, not represented in FIG. 1. The mentioned silicon unit can also be arranged upstream of the superstructure 700, for example in the area of the cooling unit 600. Furthermore, the superstructure can have, not represented in FIG. 1, a perforating unit, a gluing unit, a numbering unit and/or a plow folder. After passage through the superstructure 700, the web B, or partial webs, are conducted into a folding apparatus 800.

In an advantageous embodiment the printing press in addition has a separate transverse cutter 900, for example a so-called plano delivery device 900, in which a web B which, for example, had not been conducted through the folding apparatus 800, is cut into standard sheets and, if desired, stacked or delivered.

The units 100, 200, 300, 400, 450, 500, 600, 700, 800, 900 of the printing press have an effective width transversely in respect to the transport direction T of the web B, which permits processing of webs B of a maximum width b (FIG. 2) of, for example, up to 1,000 mm. Here, the effective width is understood to be the respective width, or clear width, of the structural components (for example, rollers, cylinders, passages, sensor devices, actuating paths, etc.) of the units 100, 200, 300, 400, 450, 500, 600, 700, 800, 900, which work together with the web B directly or indirectly, so that the web B can be processed, conditioned and conveyed in its full width b. The functionality (material supply, web transportation, sensor devices, further processing devices) of the units 100, 200, 300, 400, 450, 500, 600, 700, 800, 900 is designed in such a way that webs B′ of only partial width down to a width b′ of only 400 mm can be processed in the printing press.

The units 100, 200, 300, 400, 450, 500, 600, 700, 800, 900 which define, or process, a section length a are designed in such a way that for example they define a section a of a length between 540 and 700 mm on the web B. The section length a advantageously lies between 540 and 630 mm. In a special embodiment the section length a lies at 620±10 mm. In a further development of the printing press the units 100, 200, 300, 400, 450, 500, 600, 700, 800, 900 are designed in such a way that with a few changes the printing press can be selectively designed with section lengths of 546 mm, 578 mm or 620 mm. Thus, for example, substantially only an exchange capability of bearing elements for printing group cylinders (see below), a matching of the drive mechanism (see below), as well as matching in the folding apparatus 800 or the transverse cutter 900 (see below), are required for the change in order to equip the same printing press for formats which differ from each other. For example, in a standard way the section length a is covered by four vertical printed pages, for example DIN A4, side-by-side in the transverse direction of the web B, and two printed pages (for example of a length s) one behind the other in the longitudinal direction. However, depending on the print image and the subsequent further processing in the superstructure 700 and the folding apparatus 800, other numbers of pages per section length a are also possible.

For multi-color imprinting of the web B, B′, the printing press has several, for example at least four, here in particular five identically equipped printing units 300. The printing units 300 are preferably arranged one next to the other, and a web B, B′ passes horizontally through them. The printing unit 300 is preferably designed as a printing unit 300 for offset printing, in particular as a double printing group 300, or as an I-printing group 300, with two printing groups 301, for example two offset printing groups 301 for two-sided printing by means of the so-called rubber-against-rubber process. Rollers 302 are arranged upstream and downstream at least in the lower area, and optionally in the upper area of at least one of the printing units 300, by means of which an incoming web B, B′ can be conducted around above or below the printing unit 300, or a web B, B′ conducted around an upstream located printing unit 300 can be passed through the printing unit 300, or a web B, B′ passed through the printing unit 300 can be conducted around the downstream located printing unit 300.

FIG. 3 schematically shows the arrangement of two printing groups 301 working together via the web B, B′, each with printing cylinders 303, 304 embodied as transfer cylinder 303 and forme cylinder 304 (cylinders 303, 304 for short), an inking system 305 and a dampening system 306. In an advantageous embodiment, per forme cylinder 304 the printing unit 300 has devices 307 for semi- or fully-automatic plate feeding, or changing of a printing forme 310.

In a further embodiment, in particular if the printing press is intended to be suitable for imprinting operations, at least one or several printing units 300 have additional guide elements closely ahead of and behind the nip point of the printing unit 300. If a web B, B′ is to pass without being imprinted and without contact between it and transfer cylinder 303, the web guidance with the use of the guide elements 308, shown in dashed lines in FIG. 3, is advantageous. The web B, B′ passes through the nip point in such a way that it substantially forms an angle between 80° and 100°, preferably approximately 90°, with a connecting line of the axes of rotation of the two transfer cylinders 303. Preferably the guide elements 308 are designed as rods or rollers, around which air flows. This reduces the danger of previously freshly applied ink rubbing off.

In a further development of the represented printing group 301, a washing device 309 is assigned to each transfer cylinder 303. The elastic surface of the transfer cylinder 303 can be cleaned by means of the washing device 309.

Each of the cylinders 303, 304 has a circumference between 540 and 700 mm, wherein preferably the forme and the transfer cylinder 303, 304 have the same circumference. In an advantageous manner the circumferences lies between 540 and 630 mm. In a special embodiment the section length a lies at 620±10 mm. In a further development, the printing unit 300 is designed in such a way that, with a few changes, the cylinders 303, 304 can be selectively designed with circumferences of 546 mm, 578 mm or 620 mm. Thus, for example, substantially only an exchange of bearing elements or a changed position of the bores in the lateral frame (and the lug, see below) for the cylinders 303, 304, and a matching of the drive mechanism (lever, see below) takes place.

The transfer cylinder 303 has a least one, non-represented dressing on its circumference, which is held in at least one groove extending axially on the shell face. Preferably the transfer cylinder 303 only has one dressing extending over the effective length, or substantially over the entire width of the web B, B′ to be imprinted, and substantially extending (except for a joint of a groove opening) around the entire circumference of the transfer cylinder 303. Preferably the dressing is designed as a so-called metal printing blanket, which has an elastic layer (for example rubber) on a substantially dimensionally stable support layer, for example a thin-metal plate. Now the ends of this dressing are inserted through an opening in the shell face into the groove and are held there by frictional or positive contact. In the case of a metal printing blanket the ends are bent/beveled off (for example, in the area of its leading end by approximately 45°, and in the area of its trailing end by approximately 135°). These ends extend through an opening of a groove extending over the entire usable width of the transfer cylinder 303, which for example also has an arresting, clamping or tensioning device. The opening to the groove in the area of the shell face preferably has a width between 1 and 5 mm, in particular less than or equal to 3 mm, in the circumferential direction of the cylinder 304. The clamping device is advantageously embodied to be pneumatically operable, for example in the form of one or several pneumatically operable levers, which in the closed state are pre-tensed by a spring force against the trailing end extending into the groove. A hose which can be charged with a pressure medium can preferably be employed as operating means.

Besides an ink feeding device, for example an ink fountain 311 with an actuating device 312 for regulating the ink flow, the inking system 305 has a plurality of rollers 313 to 325. The ink-conducting device can also be designed as a doctor blade crosspiece. With the rollers 313 to 325 placed against each other, the ink moves from the ink fountain 311 via the duct roller 313, the film roller 314 and a first inking roller 315 to a first distribution roller 316. Depending on the mode of operation of the inking system 305 (see below), from there the ink moves via at least one inking roller 317 to 320 to at least one further distribution cylinder 321, 324, and from there via at least one application roller 322, 323, 325 to the surface of the forme cylinder 304. In an advantageous embodiment the ink moves from the first distribution cylinder 316 over several possible paths selectively or simultaneously (in series or parallel) via two further distribution cylinders 321, 324 to the application rollers 322, 323, 325.

As shown in dashed lines in FIG. 3 for the inking roller 317, the latter can be brought into a first position (solid lines), in which it takes the ink from the first distribution roller 316 and conducts it via the second distribution roller 324 and at least the application roller 325 to the forme cylinder 304. In principle, this path is independent of the below described paths of the ink from the first distribution roller 316 or from the second distribution roller 324 via the inking roller 318 and a third distribution roller 321 to the forme cylinder 304. In a second position (shown in solid lines) of the inking roller 317 (dashed lines), the latter has been moved away from the downstream located distribution cylinder 324, the path of the ink over the second distribution roller 324 is interrupted. In an advantageous embodiment of the inking and dampening systems 305, 306, the second distribution cylinder 324 can simultaneously work together with a roller 328, for example application roller 328, of the dampening system 306. Fluid (ink and/or dampening agent) on the second distribution cylinder 324 then can - with the rollers 324, 325, 326, as well as the cylinder 304 appropriately brought into contact with each other - be simultaneously delivered via the application rollers 325 and 328 to the forme cylinder 304.

The inking roller 318 can also advantageously be brought into two positions. In a first position (solid line shown), the inking roller 318 takes the ink off the second distribution cylinder 324, which receives the ink from the first distribution cylinder 316 via the inking roller 317 (which is in its first position). The ink is conducted from the inking roller 318, possibly via further inking rollers 319, 320, to a third distribution cylinder 321, and from there via at least one distribution roller 322, 323 to the forme cylinder 304. In a second position (shown in dashed lines) of the inking roller 318, the ink is taken directly from the first distribution cylinder 316. This second position of the inking roller 318 is of importance in particular when the inking roller 317 is in its second (dashed lines) position.

If needed, it is possible by means of the movable roller 317 to interrupt a first ink path via two distribution cylinders 316, 324 between the first and the second distribution cylinder 316, 324.

It is therefore possible by means of the movable application roller 318 to realize a direct ink path via two distribution cylinders 316, 321 arranged in series, or three distribution cylinders 316, 321, 324 arranged in series - the first regardless of whether or not the above mentioned first ink path via the second distribution cylinder 324 has been realized in addition to and parallel with this path.

The forme cylinder 304 is supplied with ink via a first front application path from the second distribution cylinder 324 via one, or possibly two application rollers 325 (328), and a second application path located in the rear from the third distribution cylinder 324 via one or several assigned application rollers 322, 323. The expression “front” and “located in the rear” application path refers to the sequence of the contact when the forme cylinder 304 rotates after conveying ink to the transfer cylinder 303.

As represented by dashed lines in FIG. 3, the application roller 318 can be brought into a first position or placement (in dashed lines), in which it takes ink from the first distribution cylinder 316 and conveys it via the application rollers 319, 320 to the second distribution cylinder 321. In a second position or placement, the application roller 318 takes the ink from a third distribution cylinder 324, which receives the ink from the first distribution cylinder 316, via the application roller 317. By means of the movable application roller 318 it is therefore possible to realize a direct path of ink via two or three distribution cylinders 316, 321, 324 arranged in series - regardless of whether or not, in addition and parallel to this path, a second path of the ink via only two distribution cylinders 316, 324 has been realized.

The inking behavior of the forme cylinder 304 can be changed and set by the inking system 305 via the roller 318. In the first mode of operation, in which the roller 318 is in the first position (shown in dashed lines in FIG. 3), more ink is transferred into the application path “located in the rear” via the second group of rollers 319, 320, 321, 322 (third distribution cylinder 321 and assigned ink and application rollers 319, 320, 322, 323) and from there to the forme cylinder 304, than in the operating mode in which the roller 318 is in its second position. In the second operating mode, ink for the rear application path is first taken from the second distribution cylinder 324. Correspondingly, in the reverse way the ink application is reduced or increased via the first group of rollers 324, 325, and possibly 328, from the direction of the second distribution cylinder 324 to the forme cylinder 304.

If not explained in another way, the rollers or distribution cylinders assigned to the inking system 305 or the dampening system 306 are understood to be those rollers or distribution cylinders, which, with the inking and dampening systems operated separately, are assigned with their basic function, i.e. in this example a distribution cylinder 329 in the dampening system 306, and three distribution cylinders 316, 321, 324, in the inking system 305 when dampening agent application and ink application are separated.

As also indicated by dashed lines in FIG. 3, the roller 328 preferably can also be brought into two operating positions wherein, as explained above, in a first position (shown in a solid line) it is placed against the second distribution cylinder 324, and in a second position (shown in dashed lines) it is moved away from it. In this case the contact can be provided from the application roller 328 of the dampening system 306 to the distribution cylinder 324 (“of the inking system” 305), where an ink/dampening agent emulsion is formed. However, in both positions it works together with forme cylinder 304 on the one, and with a further roller 329 of the dampening system 306, for example a distribution roller 329, in particular a traversing chromium roller 329. The chromium roller 329 receives the dampening agent from a moistening arrangement, for example a roller 330, in particular a dipping roller 330, which dips into a dampening agent supply 332, for example a water fountain. A drip pan 335 is preferably arranged underneath the water fountain for catching condensation water forming on the water fountain which, in an advantageous embodiment, is designed to be heatable, for example by means of a heating spiral.

The mobility of the rollers 317, 318, 328 is not to be understood to be the customary setting capability for adjustment purposes, but instead the operational mobility for resetting from one operating position into the other. This means that actuating means and/or stops (for example, adjustable ones), which can be operated manually or by means of drive mechanisms, are provided for the one, as well as the other operating position. Furthermore, there is a longer permissible actuating path, or the roller arrangement has been correspondingly selected in such a way that the two positions can be reached over the customary actuating path.

In an advantageous embodiment, the chromium roller 329 and the roller 330 are each seated, for example on levers, so they can be moved in a direction perpendicular to their axis, so that the position of the application roller 328 can be changed in the above mentioned way.

The distribution cylinders 316, 321, 324 of the inking system 305, as well as the roller 329 of the dampening system 306 are seated, axially movable, in lateral frames (not represented in FIG. 3) in such a way that they can perform a traversing movement. The traversing movement of the distribution cylinders 316, 321, 324 and the roller 329 takes place in a forced manner, coupled via appropriate gears with the respective rotatory drive mechanism. A seating which permits traversing is also provided for the roller 328 and the application roller 323. However, in contrast to the first mentioned distribution cylinders 316, 321, 324 and the roller 329, the axial movement is merely caused by mechanical friction of the shell faces working together, and not by means of an appropriate traversing gear. Such seating, which makes possible degrees of freedom in the axial direction, can also be provided optionally for the two application rollers 322 and 325.

The arrangement in the inking and dampening systems 305, 306, shown in solid lines in FIG. 3, represents the working together of the rollers 313 to 325 and 328 to 330 provided for “normal” printing operations. Ink and dampening paths are also connected by means of the second distribution cylinder 324, besides via the forme cylinder 304. Indirect dampening also takes place, besides direct dampening.

A mode of operations is schematically represented in FIG. 4 (only for the upper printing group 301), wherein the roller 317, moved away from the second distribution cylinder 324 (shown in dashed lines), remains placed against the distribution cylinder 316 (shown in dashed lines) and in a further development is simultaneously placed against the roller 314. At the same time the roller 318 is moved away from the second distribution cylinder 324 and placed against the first distribution cylinder 316. Thus, the ink path runs via the first and third distribution cylinders 316, 321. The application roller 328 of the dampening system 306 is in contact with the second distribution cylinder 324, so that the application of dampening agent takes place directly and via five rollers 324, 325 and 328 to 330 (five roller dampening system). Because of the displacement capability of the roller 317, and possibly 318, one of three distribution cylinders 316, 321, 324 of the inking system 305 and an application roller 325 can therefore be assigned to the dampening system 306. This mode of operation of the inking and dampening systems 305, 306 is particularly suited when operating with special inks, in particular inks with a large metallic proportion, and/or if no indirect dampening is to take place for other reasons (for example emulsification behavior and/or unnecessary roller soiling).

FIG. 5 schematically shows (only for the upper printing group 301) a mode of operation in which the roller 328 has been moved away from the second distribution cylinder 324 (shown in solid lines), but remains placed against the roller 329, as well as the forme cylinder 304. Dampening takes place only via the three rollers 328 to 330. In a variation not represented, inking can take place simultaneously via all rollers 322, 323, 325 of the inking system 305 with the application rollers 322, 323, 325 in contact. In the variation shown, however, the application rollers 322, 323, 325 are simultaneously moved away from the forme cylinder 304 (indicated by arrows), and the drive mechanism of the inking system 305 is, for example, decoupled or stopped. The last mentioned variation is particularly suited for the mode of operation of the inking and dampening system 305, 306 in connection with the so-called blind plate operation, i.e. when the assigned forme cylinder 304, or its printing forme, does not contain an image to be imprinted. Thus, because of the capability of the roller 328 to be displaced, a selection between direct dampening in the “three roller dampening system” and - as a function of the position of the roller 317 - indirect dampening, or direct dampening in the “five roller dampening system” is possible.

In an advantageous embodiment of the inking system 305 the rollers 313, 314, 315, which have been placed against each other, are arranged in such a way that, in the contacted position, connections V1, V2 of the axes of rotation of the rollers 313 and 315 substantially form a right angle of approximately 90° with the respective axis of rotation of the roller 314, i.e. 80°<alpha<100°, in particular 85°<alpha<95°. In an advantageous further development a connection V3 between the contact point, for example the contact point of the actuating device 312 at the roller 313, also substantially forms a right angle with the axis of rotation of the roller 313, i.e. 80°<beta<100°, in particular 85°<beta 95°, for connecting the axes of rotation of the rollers 313 and 314. The angles alpha, beta are oriented in such a way that the three mentioned imagined connections V1, V2 and V3 together result in a “zigzag pattern”. This arrangement is of particular advantage in view of the decoupling of undesired movements when producing radial forces, and in view of reduced soiling from ink mist.

In an advantageous embodiment the arrangement of the rollers 313 and 314 has been selected to be such that the axis of rotation of the roller 314 designed as a film roller 314 lies above the axis of rotation of the duct roller 313. Generally expressed, the arrangement has been selected in such a way that, when taking the direction of rotation of the rollers 313, 314 into consideration, the inlet side of the nip point is located lower than the outlet side. A hydrostatic wedge between the two rollers 313, 314 on the inlet side of the nip point is prevented, which could push the rollers 313, 314 apart and could result in an uneven ink distribution.

The shell face of the film roller 314 is provided to particular advantage with a surface structure 344, which only has an averaged supporting surface 346, for example elevations 346, between 5 and 15%, in particular 5 to 11%, in the effective area, and recesses 347, 348 lying between them. The mentioned portion of the supporting surface 346 of the entire effective shell face can in principle be embodied in the most diverse manner by evenly distributed recesses, milled-out places, etc. of different patterns. FIG. 6 schematically shows a particularly advantageous design of the surface structure 344, which can be produced in a simple manner and moreover has an advantageous effect in regard to taking up and releasing ink.

To this end, the surface structure 344 of the film roller 314 consists of two groups of grooves 347, 348 extending in straight lines on the surface of the roller 314. The grooves 347, 348 of each sub-group of grooves extend parallel in respect to each other and are evenly distributed over the circumferential surface of the film roller 314. The grooves 347 of the first sub-group of grooves extend at a twist angle gamma, which for example lies in the range of between 20° and 40°, in particular 25° and 35°, distributed relative to the longitudinal axis of the film roller 314 over the circumferential surface of the film roller 314. The grooves 348 of the second sub-group of grooves extend at a twist angle delta, which for example lies in the range of between −25° and −35°, in particular 28° and 38°, in relation to the longitudinal axis of the film roller 314. The grooves 347, 348 of the two sub-groups of grooves are arranged in such a way that they cross on the circumferential surface. The lozenge-shaped elevations 346 are formed between the grooves 347, 348 by the grooves 347, 348 crossing each other.

A depth t347, t348 of the grooves 347, 348 is advantageously 0.2 to 0.6 mm, at least at their lowest point, wherein the depths t347, t348 of the two grooves 347, 348 are preferably substantially identical. A width b347 of the grooves 347 advantageously is 1.0 to 1.8 mm, a width b348 of the grooves 348 advantageously 0.7 to 1.6 mm. The grooves 347, 348 extending parallel with each other should be spaced apart from each other in such a way that the lateral length of the lozenge-shaped elevations 346 on the one, longer side (for example adjoining the groove 348) are 0.5 to 1.0 mm, and on the other, shorter side (for example adjoining the groove 347) are 0.4 to 0.7 mm.

In an advantageous embodiment, the production of the grooves 347, 348 takes place by the removal of surface material 349, for example by milling. Advantageously they have a cross section substantially in the shape of an arc of a circle. This section of an arc of a circle of the wider grooves 347 has a radius, for example, in the range between approximately 0.6 to 1.0 mm, and of the narrower grooves 348 between 0.4 and 0.8 mm. Milling-out the grooves 347 extending spirally on the shell face takes place for example at a distance a347 of the center lines of 1.85 to 2.45 mm, milling-out the grooves 348 for example at a distance a348 of the center lines of 1.35 to 1.95 mm. For example, the surface material 349 is embodied as a plastic material (for example polyamide), in particular as a sinter-coated plastic material on a metallic roller base body 351, for example a metal tube, not represented, of a preferred wall thickness of 7.0 to 12 mm. Advantageously a thickness d349 (not milled, i.e. in the area of the elevation 346) of the surface material 349 lies between 0.8 and 1.2 mm.

Besides the mentioned rollers 313 to 325, the inking system 305 has at least one further roller 326, by means of which ink can be taken from the inking system 305 in the ink path, in particular upstream of the first distribution cylinder 316. This takes place in that an appropriate removal device 333 (FIG. 3) can be placed against this roller 326 itself or, as shown, against a roller 327 working together with it.

FIG. 7 shows the removal device 333 working together with the roller 327 (possibly also the roller 326, but matched to the direction of rotation). A plurality of sections 334, for example embodied as stripping elements 334, for example stripping elements 334.1 to 334.10, can be placed against the shell face. In particular, the removal device 333 has respectively at least one such stripping element 334, at least in an edge area of the roller 327. For example, no stripping elements 334 are provided in the area of a central zone 340 (non-effective zone 340) of the roller 327. In a non-represented variation, stripping elements 334 can also be provided in the zone 340 which, however, are adjusted or set as required in such a way that they do not come into contact with the shell face when the removal device is brought into contact. Depending on bringing one or several stripping elements 334 in or out of contact, especially in the edge area, ink can be taken out of the corresponding section of the roller 327 and can be caught, for example, in a reservoir 336 and returned again in a further development of the ink guidance device. This section represents a zone 331, which is effective in respect to ink removal, in particular a contact zone 331. Thus, ink is removed (sink) via the roller 327 in this section of the roller 315, and therefore also possibly in the subsequent ink path to the forme cylinder 304 (partially by means of re-inking). It is therefore possible to set an ink flow in the inking system 305 to a web width b, b′ of the web B, B′ to be imprinted by setting defined stripping elements 334 from the respective edge section of the roller 327. In the example of FIG. 7, respectively one group of several stripping elements 334, in this case five stripping elements 334.1 to 334.5, and 334.6 to 334.10, have been arranged side-by-side, substantially ending flush with each other, from the direction of each edge area of the roller 327. It is possible to arrange a section without stripping elements 334 (corresponding to a minimum width b′ of a web B′ to be imprinted) between the two groups.

In the embodiment in accordance with FIG. 7, the stripping elements 334 are arranged on a common spindle 337 and can be brought into and out of contact by pivoting the spindle 337 by means of a drive mechanism 338, in this case a cylinder 338, which can be actuated by pressure media, on both sides. The definition of the effective stripping elements 334 here is provided by the manual setting of blades 339 via respective actuating means 341, for example lever mechanisms 341. However, in an advantageous further development the setting of the blades 339 can also take place via individual drive mechanisms, for example by means of small pressure medium cylinders, magnetically, piezo-electrically or by motors. In this case drive mechanisms which are remote-controlled, for example from a control console and/or a press control device, are advantageous.

In an embodiment not represented, the stripping elements 334 are not brought into or out of contact as a whole, setting takes place instead individually for each stripping element 334, for example by individual drive mechanisms, for example by means of small pressure medium cylinders, magnetically, piezo-electrically or by motors. Here, too, remote-controlled drive mechanisms are advantageous, for example from a control console and/or a press control device.

In connection with the variation, or embodiment, with remote-controlled drive mechanisms, a way of proceeding described in what follows is of advantage: when setting the ink flow for the product and/or the width b, b′ of the web B, B′ to be imprinted, the ink inflow from the ink fountain 311 into the inking system 305 is performed in zones by setting flow-through gaps between the ink fountain 311 and the first roller 313 (FIG. 8). This takes place, for example, in a remote-controlled manner by adjusting ink blades 343 by means of drive mechanisms, not represented in FIG. 8. If a center-running web B′ which is of only partial width is imprinted, in principle at least one of the ink blades 343 per side of the roller 313 is closed, for example. The number of ink blades 343 which basically must be closed as a result of the web width is determined by the width b, b′ of the web B, B′. Moreover, ink blades can of course be closed as a function of the print image, i.e. the ink requirement in the respective zones of the area to be imprinted.

In an advantageous embodiment, the basic setting as a function of the width of the web B, B′ is now automatically performed by the press control device as a function of the web width to be imprinted. For example, this information is available in the product information and/or in the roll changer 100. The information regarding the web width, or the information regarding closed ink blades 343, is now used for controlling the above mentioned drive mechanisms for the individually actuatable stripping elements 334 or blades 339. The stripping elements 334 or blades 339 are determined on the basis of this information, and the respective drive mechanisms are triggered. The control of ink blades 343 on the one side and the blades 339 or stripping elements 334 on the other side can also take place in parallel on the basis of mutually available information - for example regarding the web width -.

The cylinders 303, 304 and the rollers 313 to 330 of the inking and dampening systems 305, 306 are respectively seated with their ends in, or on lateral frames 352, 353, or frame walls 352, 353 (see FIG. 9). However, only the rollers 329 and 330 with their fastening and drive simulation, which will be described in greater detail below, as well as the main drive 354 of the printing unit 300, also explained below, are represented by way of example in FIG. 9.

One of the frame walls 352, 353, in particular the one on the side of the main drive 354, is designed to be in one or several parts in such a way that a lockable hollow space 356, for example lubricant chamber 356, can be formed, which extends at least over an area which covers the fronts of all cylinders 303, 304 and rotatorily driven rollers. As represented schematically in FIG. 10, a releasable cover 357 for the hollow space 356 is provided at the front. The other frame wall 352, together with a releasable cover 358 arranged at the front, also forms a hollow space 359, in which the switching and control devices 361 (dashed lines), for example in the form of a switchgear cabinet 361, among others, of the printing unit 300 are housed. In contrast to an arrangement between the printing units 300, the advantage is provided by the arrangement of the switching and control devices 361 at the front that the space between two printing units 300 is accessible from both sides. Therefore an operating side of the printing press can be freely selected. This is further aided in that a longitudinal tie-bar 362 connecting the printing units 300 can be selectively arranged on the frame wall 352 or 353.

A longitudinal tie-bar 362 connecting the printing units 300 is arranged on one of the frame walls 352, 353, for example selectively.

On the sides facing the cylinders 303, 304, the frame walls 352, 353 each have a shoulder 363 extending out of the line of the respective frame wall 352, 353. Advantageously the shoulder 363 is embodied to be of one piece with the lateral frame 352, 353 and is advantageously produced in the course of the production in a casting mold in the form of a so-called lug 363. The lug 363 has bores extending through it and the line of the frame wall 352, 353 for receiving bearings, not represented. The lug 363 extends, in particular continuously, over the front area of the forme and transfer cylinders 303, 304, but not over the front areas traversing inking or dampening systems and/or those capable of traversing.

The rollers 329 and 330 are seated on the inside of the frame walls 352, 353 in levers 364, 366, pivotable around a pivot shaft S329, S330, which extends parallel with the respective axis of rotation (see FIG. 11). However, they can also be seated in eccentric bushings. Also, one of the rollers 329, 330, in particular the roller 330, for example, can be seated in eccentric bushings, and the other, in particular the roller 329, then in levers 364, 366.

In a preferred embodiment, the pivot shaft S329 coincides with the axis of rotation of the roller 330 and is moved along with the roller 330 in the course of pivoting the lever 364. The pivot shaft S330 of the roller 330 is fixed in place on the frame. One individual rotatory drive mechanism 367, 368 per roller 329, 330, in particular a drive motor 367, 368, is provided and is also connected with the respective lever 364, 366 and moved along with the respective roller 329, 330, which individually rotatorily drives the respective roller 329, 330, mechanically independently of each other, for example via a corner or angle gear 369, 371 (see FIG. 12). The drive motor 367, 368 is preferably embodied as an electric motor 367, 368 whose number of revolutions can be regulated (in particular continuously), in particular as a rotary current motor 367, 368. Setting of the number of revolutions, or of the dampening, can take place in an advantageous manner from the control console, for example from the ink setting console, where it is also displaced. In a preferred embodiment a correlation between the speed of rotation of the press and the dampening, or the number of revolutions, is stored in the press control device, by means of which the number of revolutions, to which the two rollers 329, 330 are to be adjusted, in particular the roller 330, can be preset.

The lever 366 of the roller 330 can have an adjustable stop 365, by means of which it is supported in the contact position of the dampening system 306 on a stop 370 of the application roller 328, which works together with the roller 329.

The respective lever 364, 366 can be pivoted by a drive mechanism 372, 373, in particular cylinders 372, 373 which can be charged with a pressure medium. The rollers 329, 330 are seated, preferably on both sides, on the two frame walls 352, 353 in respective levers 364, 366, each with drive mechanisms 372, 373 for the pivoting movement (see FIG. 11).

On the front end opposite the rotatory drive mechanism, the roller 329 has a traversing drive 374, in particular a gear 374 for generating an axial traversing movement from the rotary movement. This gear 374 is preferably arranged outside the roller body in order to avoid generation of heated spots of frictional heat in the roller 329. In an advantageous embodiment, the gear 374 is located on the drive side of the printing group 300, i.e. in the area of the same frame wall as the main drive 354, and/or a drive train of the printing group cylinders, however the rotatory drive mechanism of the rollers 329 and 330 on the opposite side, i.e. in the area of the frame wall 352. If the hollow space 356 is embodied as a lubricant chamber 356, the gear 374 can be arranged in it as an open gear, not separately lubricated. On the side remote from the gear 374, the roller 329 is seated on a with the motor shaft via the corner gear 369 and an angle-compensating coupling 375, for example a hypoid-tooth coupling device, and a shaft 376, via coupling means 377, for example, embodied as a bearing 377, in particular axial bearing, in such a way that a rotatory movement is transmitted, but an axial movement of the roller 329 in regard to the roller 376 is possible (FIG. 13). Advantageously the bearing 377 is embodied as a ball-bearing sleeve, which transmits torque, wherein balls which run, for example, in longitudinal grooves of the shaft 376, as well as of the bearing body, transmit a torque, but keep the bearing body axially movable in relation to the shaft 376. For example, the bearing body is connected, fixed against relative rotation, with the roller body of the roller 329.

FIG. 14 shows an advantageous embodiment of the gear 374 in the area of the other front face of the roller 329, which in principle is embodied based on the function of a cam gear with a groove 400 extending in a curved shape and an engaging stop 401. An outer sleeve 378 with inner teeth is fixedly connected with the lever 364 and supports the stop 401 (or the groove 400). An inner bushing 381, which supports the groove 400 (or the stop 401) is connected via a flexible, but torsion-proof connector 379 (hinged or having flexural strength) with an annular gear 380 with teeth on the exterior. The annular gear 380 is rotatably seated on an eccentric device 383, which is connected, torsion-proof, but eccentrically in respect to the axis of rotation of the roller 329, via a shaft 385 with the latter. When the roller 329 rotates, the eccentric device 382 rotates and lets the annular gear 380 roll off on the inner teeth, in the course of which the inner bushing 381 is caused to rotate in relation to the outer bushing 378 fixed on the lever. A gear reduction ratio between the rotation of the roller 329 and the inner bushing 381 is determined by the tooth ratio between the inner teeth and the annular gear 380. The axial movement of the inner bushing forced by the curve of the groove 400 is transmitted as a traversing movement to the roller 329 via the connector 379, which can be charged with pressure and tension, a seating between the eccentric device 382 and the annular gear 380, which can be charged with pressure and tension, and the roller 385.

The for the arrangement of the traversing roller 329 or the roller 330 in levers 364, 366, the individual rotatory drive via the lever 364, 366 assigned drive motors 367, 368, possibly via corner gears 369, 371, as well as in case of the traversing motion the arrangement of the drive motor 367, 368 and traversing gear 374 on the described sides of the press can be transferred in the same way to one or several of the rollers of the inking system 305, and should therefore be understood as such.

As can already be seen in FIG. 9, driving of the cylinders 303, 304 of the printing unit 300 is performed via a main drive 354, for example an electric motor 354 fixed in place on the frame, in particular via an electric motor 354 whose angular position can be regulated and which is advantageously embodied to be water-cooled. The arrangement of the drive mechanism is represented in FIG. 15, starting at the frame wall 353 and viewed toward the outside. With its pinion gear (arrow in dashed lines), not visible in FIG. 15, the electric motor 354 does not drive directly on a drive wheel 386, 387 of one of the cylinders 303, 304, but via an intermediate wheel 384. The intermediate wheel 384 is seated in a lever 388, which is seated to be pivotable in principle around an axis of rotation R383 of the pinion gear 383. With the position of the electric motor 354 fixed in place in regard to the frame wall 353 of the frame, an adaptation of printing units 300 of different formats to different cylinder circumferences (and therefore different circumferences of the drive wheels 386, 387) can take place in a simple manner. Depending on the format of the printing unit 300, the lever 388 is pivoted during mounting in such a way that the intermediate wheel 384 is in optimal engagement with the respective drive wheel 386, 387. Fixation elements 389, for example bolts 389 and corresponding bores, not represented, are advantageously provided (on the drive unit and/or in the frame wall 353), by means of which the aligned lever 388, after having been mounted in the respective position in regard to the frame wall 353 and/or the electric motor 354, can be fixed in place. The bores relevant for the respective format are preferably already prepared during the manufacturing of the structural parts in the factory. In a printing unit 300, or printing press, for a first format (section length a), the lever 388 is fixed in respect to a vertical line in a different position than in a printing unit 300, or printing press, for a second format (section length a), wherein the electric motor 354 maintains its position in respect to the frame wall 353.

In principle, driving can take place from the intermediate wheel 384 on any arbitrary one of the drive wheels 386, 387. However, preferably driving first takes place on the drive wheel 387 of one of the two forme cylinders 304. From there, driving takes place on the drive wheel 386 of the associated transfer cylinder 303, from there on the other transfer cylinder 303 and finally on the second forme cylinder 304. The drive wheels 386, 387 are connected, fixed against relative rotation, for example via journals, with the respective cylinder 303, 304. Rotatory driving on one or several rollers 313 to 327 of the associated inking systems 305 takes via further drive wheels 391, which are connected, fixed against relative rotation, with the two forme cylinders 304. Advantageously the distribution cylinders 316, 321, 324 are rotatorily driven from the direction of the forme cylinder 304 via a positively connected drive mechanism, the duct roller 313 has its own rotatory drive mechanism, for example its own, mechanically independent drive motor, not represented. The remaining rollers 313, 315, 317 to 320, 322, 323 and 325 to 327 of the inking system 305 are only rotatorily (and possibly axially, see above) driven by means of friction.

In an advantageous manner, driving takes place via an intermediate wheel 392 on drive wheels 393, 394 of the two distribution cylinders 321, 324 (FIG. 16). The intermediate wheel 392 is preferably designed to be coupled or decoupled, so that the respective drive train and the forme cylinder 304 can be mechanically separated from each other (the non-represented drive train in the lower printing group 301 follows correspondingly). From the drive wheel 393 of the distribution cylinder 324, driving is performed via a further intermediate wheel 395 on a drive wheel 398 of the distribution cylinder 316. The drive or intermediate wheels 392 to 396 are preferably designed as gear wheels 392 to 396. The drive connections have been designed in such a way that an axial movement of the distribution cylinders 316, 321, 324 is made possible.

As indicated in FIG. 3 and already mentioned above, in an advantageous embodiment the printing group 301 has the device 307 for the - at least semi-automatic - changing of a printing forme 310 on the assigned forme cylinder 304. The device is designed in two parts and has a contact pressure device 397, also called “semi-automatic changer” 397, arranged in the area of a nip point between the forme and transfer cylinders 303, 304, and a magazine 398, structurally separated from it, with feeding and receiving devices for the printing formes 310.

In an advantageous further development, the printing unit 300 has a device 399 for affecting the fan-out effect, i.e. for affecting a change in the transverse extension/width of the web B from one print location to the other, caused by the printing process (in particular moisture). To this end at least one nozzle is arranged on a cross-beam in such a way that gas, in particular air, flowing out of it is directed onto the web B. B′. Depending on the force of the flow, the web B, B′ undulates more or less when passing through this area, which results in a correction of the width b, b′ and of the lateral alignment of each partial area of the printed image.

### LIST OF REFERENCE SYMBOLS

100 Unit, roll unwinding device, roll changer
200 Unit, draw-in unit
300 Unit, printing unit, double-printing group, I-printing group
301 Printing group, offset printing group
302 Roller,
303 Cylinder, printing group cylinder, transfer cylinder
304 Cylinder, printing group cylinder, forme cylinder
305 Inking system
306 Dampening system
307 Devices for semi- and fully automatic plate feeding
308 Guide element
309 Washing device
310 Printing forme
311 Ink supply, ink fountain
312 Actuating device
313 Roller, duct roller
314 Roller, film roller
315 Roller, inking roller
316 Roller, distribution cylinder
317 Roller, inking roller
318 Roller, inking roller
319 Roller, inking roller
320 Roller, inking roller
321 Roller, distribution cylinder
322 Roller, application roller
323 Roller, application roller
324 Roller, distribution roller
325 Roller, application roller
326 Roller
327 Roller
328 Roller, application roller
329 Roller, distribution roller, chromium roller
330 Roller, dipping roller
331 Contact zone, effective zone
332 Dampening agent supply
333 Removal device
334 Section, stripping element
335 Pot plate
336 Reservoir
337 Spindle
338 Drive mechanism, cylinder
339 Blade
340 Non-effective zone
341 Actuating means, lever mechanism
342 —
343 Ink blade
344 Surface structure
345 —
346 Surface, elevation
347 Recess, groove
348 Recess, groove
349 Surface material
350 —
351 Roller base body
352 Lateral frame, frame wall
353 Lateral frame, frame wall
354 Main drive, electric motor, controllable
355 —
356 Hollow space, lubricant chamber
357 Cover
358 Cover
359 Hollow space
360 —
361 Switching and control devices, switchgear cabinet
362 Longitudinal tie-bar
363 Shoulder, lug
364 Lever
365 Stop (366)
366 Lever
367 Individual drive, drive motor, rotary current motor
368 Individual drive, drive motor, rotary current motor
369 Corner or angle gear
370 Stop (366)
371 Corner or angle gear
372 Drive mechanism, cylinder
373 Drive mechanism, cylinder
374 Gear, traversing gear
375 Coupling
376 Shaft
377 Bearing, coupling means
378 Bushing
379 Connection, flexible but torsion-proof
380 Annular gear
381 Bushing
382 Eccentric device
383 Pinion gear
384 Intermediate wheel
385 Shaft
386 Drive wheel
387 Drive wheel
388 Lever
389 Fixation element, bolt
390 —
391 Drive wheel
392 Intermediate wheel, gear wheel
393 Drive wheel, gear wheel
394 Drive wheel, gear wheel
395 Intermediate wheel, gear wheel
396 Drive wheel, gear wheel
397 Contact pressure device, semi-automatic changer
398 Magazine
399 Device for affecting the fan-out effect
400 Groove
401 Stop
402 to 449 —
450 Unit, varnishing unit
500 Unit, dryer
600 Unit, cooling unit
700 Unit, superstructure
800 Unit, folding apparatus
900 Unit, transverse cutter, plano delivery device
334.1 Stripping element
334.2 Stripping element
334.3 Stripping element
334.4 Stripping element
334.5 Stripping element
334.6 Stripping element
334.7 Stripping element
334.8 Stripping element
334.9 Stripping element
334.10 Stripping element
a Section length
s Length
b Width (B)
b′ Width (B′)
T Transport direction
R383 Axis of rotation
S329 Pivot shaft
S330 Pivot shaft
V1 Connection
V2 Connection
V3 Connection
a347 Distance
a348 Distance
d349 Thickness
t347 Depth
t348 Depth
alpha Angle
beta Angle
gamma Twist angle
delta Twist angle

1-46. (canceled)

47. A roller adapted for use with at least one of an inking system and a dampening system of a printing press comprising:
means supporting said roller for traversing movement in an axial direction of said roller;
a rotatory drive mechanism including a drive motor adapted to rotate said roller about said axis of rotation; and
means supporting said roller and said drive motor for movement in a direction perpendicular to said axis of rotation.

48. The roller of claim 47 further including spaced pivotable levers supporting spaced ends of said roller, said drive motor being positioned on one of said pivotable levers and being pivotable with said transversely movable roller.

49. The roller of claim 47 further including a traversing gear arranged at a first end of said roller and wherein said drive motor is supported at a second end of said roller.

50. The roller of claim 47 wherein said rotatory drive mechanism is fixed in place in said axial direction of said roller and includes a coaxial drive shaft and a coupling, said coupling allowing said traversing movement of said roller with respect to said drive shaft.

51. The roller of claim 47 further including pivotable eccentric bushings supporting first and second spaced ends of said roller and wherein said drive motor is supported on one of said pivotable eccentric bushings.

52. A roller adapted for use with at least one of an inking system and a dampening system of a printing press comprising:
a roller body including spaced first and second ends;
a traversing gear at said first end of said roller body and adapted to move said roller in a direction of an axis of rotation of said roller body;
a drive mechanism located at said second end of said roller body and adapted to rotate said roller body about said axis of rotation of said roller body; and
a coaxial drive shaft and a coupling in said drive mechanism, said drive shaft being fixed in place in said direction of said axis of rotation of said roller body, said coupling being adapted to transmit a torque from said drive mechanism to said roller body and to permit axial movement between said drive shaft and said roller body.

53. The roller of claim 52 wherein said drive mechanism includes an independent drive motor.

54. The roller of claim 47 wherein said rotating drive mechanism includes a bevel gear.

55. The roller of claim 50 wherein said coupling is an angle-compensating coupling.

56. The roller of claim 47 wherein said means supporting said roller for traversing movement is located exterior of said roller.

57. The roller fo claim 47 wherein said means supporting said roller for traversing movement includes a traversing gear adapted to convert rotatory movement of said roller into said traversing movement of said roller.

58. The roller of claim 57 wherein said traversing gear is an open, not individually lubricated gear, and further including at least one drive wheel of a printing group cylinder of said printing press, said traversing gear and said at least one drive wheel being located in a lubricant chamber.

59. The roller of claim 57 wherein said traversing gear is a cam gear and further including a reduction gear between said roller and said cam gear.

60. The roller of claim 57 wherein said traversing gear is a cam gear including a rotating gear member and a fixed stop member.

61. A fluid application system of a rotary printing press comprising:
a first roller having a first roller axis of rotation;
a second roller working with said first roller in a print-on position, said second roller having a second roller axis of rotation;
a first pivotable lever supporting said first roller for rotation about said first roller axis of rotation, said first pivotable lever being pivotable about a first pivot shaft; and
a second pivotable lever supporting said second roller for rotation about said second roller axis of rotation, said second pivotable lever being pivotable about a second pivot shaft, said first pivot shaft connecting with said second roller axis of rotation.

62. The fluid application system of claim 61 wherein said first pivotable lever is supported on said second pivotable lever.

63. The fluid application system of claim 61 further including an adjustable stop cooperating with said second pivotable lever and a stop cooperating with said first pivotable lever, said adjustable stop being engageable with said stop.

64. The fluid application system of claim 61 further including an adjusting device for said second roller and adapted to displace said second roller axis of rotation with respect to said first roller axis of rotation.

65. The fluid application system of claim 61 wherein said first roller is a traversing roller.

66. The fluid application system of claim 61 further including a drive motor for said second roller.

67. The fluid application system of claim 61 wherein said first roller is a distribution roller of a dampening system of said printing press.

68. The fluid application system of claim 67 wherein said second roller is a dampening roller of said dampening system.
